(19) United States
(12) Patent Application Publication
(10) Pub. No.: US 2026/0072203 A1
(43) Pub. Date: Mar. 12, 2026

(54) TUNABLE AND SWITCHABLE MID-INFRARED PERFECT ABSORBERS AND METHODS OF USE THEREOF

(71) Applicant: The Board of Regents of the University of Oklahoma, Norman, OK (US)

(72) Inventors: Sarah Safura Sharif, Norman, OK (US); Yaser Michael Banad, Norman, OK (US)

(21) Appl. No.: 19/323,790

(22) Filed: Sep. 9, 2025

Related U.S. Application Data
(60) Provisional application No. 63/693,003, filed on Sep. 10, 2024.

(51) Int. Cl. G02B 5/00; B82Y 20/00; G02B 1/00; G02B 1/02; G02F 1/015

(52) U.S. Cl. CPC G02B 5/003; B82Y 20/00; G02B 1/002; G02B 1/02; G02F 1/0155

(57) ABSTRACT

An aperiodic absorber nanostructure, comprising a substrate; a first semiconductor absorber layer in contact with a planar surface of the support substrate; a plurality of dielectric layers; a plurality of graphene layers alternated with the plurality of dielectric layers to form a stack ending with a last dielectric layer; and a second semiconductor absorber layer in contact with the last dielectric layer; and wherein the thickness of each of the plurality of layers is configured such that the nanostructure achieves a desired absorption level of a mid-infrared wavelength. A method of constructing the nanostructure. A method of using the nanostructure as a perfect absorber by exposing the aperiodic absorber nanostructure to a mid-IR source.

### CROSS-REFERENCE TO RELATED APPLICATIONS

This application claims the benefit of U.S. Provisional Patent Application Ser. No. 63/693,003, filed Sep. 10, 2024, the content of which is hereby expressly incorporated herein by reference in its entirety.

### GOVERNMENT SUPPORT

Not applicable.

### BACKGROUND

Currently available technologies in the field of mid-infrared (mid-IR) perfect absorbers (PAs) primarily rely on periodic structures and fixed designs, which lack the flexibility to precisely tune absorption properties. Traditional designs, such as those using metal-dielectric composites, face limitations in their ability to provide dynamic tunability and often suffer from bulkiness and complex fabrication processes.

Examples of existing technologies include: Metal-Dielectric Multilayer Structures, Metamaterial Absorbers, and Graphene-Based Absorbers. However, systems using Metal-Dielectric Multilayer Structures often require complex fabrication and lack tunability, resulting in fixed absorption characteristics that are not easily adjustable for specific applications. Likewise, while Metamaterial Absorbers can achieve high absorption, their design complexity and lack of dynamic control limit their practical applicability in varying atmospheric conditions. Previous Graphene-Based Absorbers designs using graphene have shown potential, but they typically rely on periodic structures, which do not offer the same level of tunability and precision as aperiodic designs.

U.S. Pat. No. 11,121,279 entitled “Electrically Controllable and Tunable Electromagnetic-Field Absorber/Emitter Using Graphene/2D Material Multilayer Nanostructures” discloses improved tunable nanostructures. However, the need for dynamically tunable and easily adjustable Perfect Absorbers has remained. It is to address this deficiency that the present disclosure is directed.

### BRIEF DESCRIPTION OF THE DRAWINGS

The accompanying drawings, which are incorporated in and constitute a part of this specification, illustrate one or more implementations described herein and, together with the description, explain these implementations. The drawings are not intended to be drawn to scale, and certain features and certain views of the figures may be shown exaggerated, to scale or in schematic in the interest of clarity and conciseness. Not every component may be labeled in every drawing. Like reference numerals in the figures may represent and refer to the same or similar element or function. The patent or application file contains at least one drawing executed in color. Copies of this patent or patent application publication with color drawing(s) will be provided by the Office upon request and payment of the necessary fec.

FIG. 1A is a perspective view of a schematic of an exemplary perfect absorber in accordance with the present disclosure.

FIG. 1B is a side view of the exemplary perfect absorber of FIG. 1A in accordance with the present disclosure.

FIG. 1C is a cross-sectional view of the exemplary perfect absorber of FIG. 1A in accordance with the present disclosure.

FIG. 2 is a schematic of a portion of an exemplary graphene layer of the perfect absorber of FIG. 1.

FIG. 3 is a process flow diagram of a method for obtaining an optical response of randomized multilayers of a perfect absorber in accordance with the present disclosure.

FIG. 4 is a process flow diagram of a method for refining aperiodic multilayer structures for optimal absorptance in accordance with the present disclosure.

FIG. 5 is a schematic of exemplary perfect absorbers in accordance with the present disclosure.

FIG. 6 is a chart of absorption spectra of the exemplary absorbers of FIG. 5, in accordance with the present disclosure.

FIG. 7A shows a comparison of absorption performance between an optimized structure and non-optimized structures with uniform layer thicknesses. (a) The absorption spectrum of a structure (Structure 1) having the optimized design generated using the inverse design framework, which achieves 100% absorption at 4 μm. (b)-d) The absorption spectrum of a non-optimized structure (Structure 2) with equal thickness layers having the maximum thickness (487.67 nm) derived from Structure 1. (c) The absorption spectrum of a non-optimized structure (Structure 3) with equal thickness layers having a minimum thickness (62.17 nm) derived from Structure 1. (d) The absorption spectrum of a non-optimized structure (Structure 4) with equal thickness layers having the average thickness (274.92 nm) derived from Structure 1. None of these configurations achieves perfect absorption. Only 50%, 32%, and 18% are achieved at 4 μm in Structures 2, 3, and 4, respectively, which highlights the importance of precise thickness tuning.

FIG. 7B shows a structural comparison showing the material layer distributions in each design of the structures of FIG. 7A.

FIG. 8 is a chart indicative of the impact of varying chemical potential on absorption characteristics of an exemplary absorber in accordance with the present disclosure.

FIG. 9(a): Simulated using the finite-difference time-domain (FDTD) method, this plot shows the normalized electric field intensity along the z-direction for multiple values of graphene chemical potential (μc=0 to 1 eV). The simulation domain includes the air region above the structure, which allows visualization of both external and internal field behavior. At μc=0.0 eV, where the structure is optimized for maximum absorption, the electric field in the air remains nearly constant, exhibiting an almost flat profile. This behavior indicates excellent impedance matching at the air-absorber interface, with negligible reflection—a hallmark of perfect absorption. As μc increases, the field confinement inside the multilayer weakens, confirming the switchable nature of the absorber. (b): Simulated using COMSOL Multiphysics, this panel shows the spatial distribution of the electric field inside the structure for two states: μc=0 eV, with strong field localization, and μc=1 eV, where the internal field intensity is significantly reduced. This independently confirms the tunable suppression of absorption.

FIG. 10 shows (a) electrical switchability of the absorber across all nine optimized structures (a-i) within the 3-5 μm range. Absorption is shown at two chemical potential states: μc=0 eV (red) and μc=1 eV (blue), revealing reduced absorption with increased μc while maintaining peak alignment, (b) absorption spectrum of the structure optimized at 4 μm, showing a peak absorption drop from 100% to 56%, and (c) material-wise absorption contribution for the same 4 μm structure at μc=0 eV and μc=1 eV. At higher μc, absorption in graphene drops to 2%, and 44% of the incident energy remains unabsorbed, demonstrating strong electrical switchability.

FIG. 11 is a chart indicative of the effect of incident angle on of an exemplary absorber in accordance with the present disclosure.

FIG. 12 is a chart indicative of the impact of altering the chemical potential and incident angle on the absorption spectrum of an exemplary absorber, optimized for an absorption peak at 4 μm, in accordance with the present disclosure.

FIG. 13 is a chart indicative of the impact of varying the incident angle on the absorption spectrum of an exemplary absorber, optimized for an absorption peak at 4 μm for Transverse Electric (TE) polarization, in accordance with the present disclosure.

FIG. 14 is a chart indicative of the impact of varying the incident angle on the absorption spectrum of an exemplary absorber, optimized for an absorption peak at 4 μm for Transverse Magnetic (TM) polarization, in accordance with the present disclosure.

### DETAILED DESCRIPTION

The present disclosure is directed to aperiodic multilayer nanostructures designed as tunable and switchable Perfect Absorbers (PAS) for the mid-infrared (mid-IR) spectrum. In non-limiting embodiments, graphene-based nanophotonic layers are utilized to provide PAs having precise absorption control within the 3 μm to 5 μm range, e.g., targeting 0.25 μm intervals.

The present disclosure describes aperiodic absorber nanostructures and their methods of use and methods for making aperiodic absorber nanostructures. The problem of developing a dynamically tunable and easily adjustable PA is addressed herein by using an aperiodic multilayer structure with graphene-based nanophotonic layers, which may be designed by using a micro-genetic algorithm within an inverse design framework. This approach allows for precise control of light absorption by adjusting layer thickness, thus providing a more versatile and practical solution for applications requiring precise mid-IR absorption control. The following detailed description refers to the accompanying drawings. The same reference numbers in different drawings may identify the same or similar elements.

In various non-limiting embodiments, the mid-IR PAs of the present disclosure can be employed in devices for the following uses.

### Environmental Monitoring:

Gas detection and analysis devices having the disclosed PAs can be used to detect and monitor various gases, including but not limited to, greenhouse gases such as CO₂ and methane.

### Thermophotovoltaics

The disclosed PAs can be used in thermophotovoltaic devices, e.g., solar panels, to enhance their efficiency by optimizing the absorption of specific wavelengths of light, resulting in more efficient solar energy harvesting systems with improved performance in varying environmental conditions.

### Sensing and Imaging:

The disclosed PAs can be used in mid-IR range advanced imaging systems, including infrared cameras and environmental sensors, enhancing the sensitivity and accuracy of infrared detectors and sensors and making them useful for security, medical imaging, and industrial inspection.

### Stealth Technology:

The disclosed PAs can be used by military and aerospace companies in materials able to absorb radar and infrared signals, thereby enhancing stealth capabilities. Incorporating the PAs into the surface materials of aircraft or vehicles can reduce their detectability by enemy sensors.

### Secure Communications:

The disclosed PAs, with their precise control of mid-IR absorption properties, can be used in advanced secure communication devices and systems to ensure signal integrity, reduce interception risk, and enhance signal concealment.

### Medical Diagnostics:

The disclosed PAs can be used in non-invasive medical diagnostic tools and devices to improve the sensitivity and specificity of diagnostic tests, for example in applications that detect biomarkers in breath or skin emissions.

Before describing various embodiments of the present disclosure in more detail by way of exemplary description, examples, and results, it is to be understood that the present disclosure is not limited in application to the details of methods and compositions as set forth in the following description. The present disclosure is capable of other embodiments or of being practiced or carried out in various ways. As such, the language used herein is intended to be given the broadest possible scope and meaning; and the embodiments are meant to be exemplary, not exhaustive. Also, it is to be understood that the phraseology and terminology employed herein are for the purpose of description and should not be regarded as limiting unless otherwise indicated as so. Moreover, in the following detailed description, numerous specific details are set forth to provide a more thorough understanding of the disclosure. However, it will be apparent to a person having ordinary skill in the art that the embodiments of the present disclosure may be practiced without these specific details. In other instances, features which are well known to persons of ordinary skill in the art have not been described in detail to avoid unnecessary complications of the description.

Unless otherwise defined herein, scientific and technical terms used in connection with the present disclosure shall have the meanings that are commonly understood by those having ordinary skill in the art. Further, unless otherwise required by context, singular terms shall include pluralities and plural terms shall include the singular.

All patents, published patent applications, and non-patent publications mentioned in the specification are indicative of the level of skill of those skilled in the art to which the present disclosure pertains. All patents, provisional applications, published patent applications, and non-patent publications referenced in any portion of this application, including but not limited to U.S. Pat. No. 11,121,279B2, are herein expressly incorporated by reference in their entirety to the same extent as if each individual patent or publication was specifically and individually indicated to be incorporated by reference.

As utilized in accordance with the methods and compositions of the present disclosure, the following terms, unless otherwise indicated, shall be understood to have the following meanings:

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or when the alternatives are mutually exclusive, although the disclosure supports a definition that refers to only alternatives and “and/or.” The use of the term “at least one” will be understood to include one as well as any quantity more than one, including but not limited to, 2, 3, 4, 5, 6, 7, 8, 9, 10, 15, 20, 30, 40, 50, 100, or any integer inclusive therein. The term “at least one” may extend up to 100 or 1000 or more, depending on the term to which it is attached; in addition, the quantities of 100/1000 are not to be considered limiting, as higher limits may also produce satisfactory results. In addition, the use of the term “at least one of X, Y and Z” will be understood to include X alone, Y alone, and Z alone, as well as any combination of X, Y and Z. The term “plurality” generally refers to two or more items. Unless otherwise required by context, singular terms shall include pluralities and plural terms shall include the singular. Where used herein, the specific term “single” is limited to only “one,” and a “pair” means two.

As used herein, all numerical values or ranges include fractions of the values and integers within such ranges and fractions of the integers within such ranges unless the context clearly indicates otherwise. Thus, to illustrate, reference to a numerical range, such as 1-10 includes 1, 2, 3, 4, 5, 6, 7, 8, 9, 10, as well as 1.1, 1.2, 1.3, 1.4, 1.5, etc., and so forth. Reference to a range of 1-50 therefore includes 1, 2, 3, 4, 5, 6, 7, 8, 9, 10, 11, 12, 13, 14, 15, 16, 17, 18, 19, 20, etc., up to and including 50, as well as 1.1, 1.2, 1.3, 1.4, 1.5, etc., 2.1, 2.2, 2.3, 2.4, 2.5, etc., and so forth. Reference to a series of ranges includes ranges which combine the values of the boundaries of different ranges within the series. Thus, to illustrate reference to a series of ranges, for example, of 1-10, 10-20, 20-30, 30-40, 40-50, 50-60, 60-75, 75-100, 100-150, 150-200, 200-250, 250-300, 300-400, 400-500, 500-750, 750-1,000, includes ranges of 1-20, 10-50, 50-100, 100-500, and 500-1,000, for example. Thus a reference to degrees such as 1 to 90 is intended to explicitly include all degrees in the range.

As noted above, any numerical range listed or described herein is intended to include, implicitly or explicitly, any number or sub-range within the range, particularly all integers, including the end points, and is to be considered as having been so stated. For example, “a range from 1.0 to 10.0” is to be read as indicating each possible number, including integers and fractions, along the continuum between and including 1.0 and 10.0, that is, having a minimum value equal to or greater than 1.0 and a maximum value equal to or less than 10.0, such as, for example, 3.25 to 8.65. Similarly, the wavelength range of 3 μm to 5 μm includes all fractional values within the range such as 3.0, 3.05, 3.1, 3.15, 3.2, 3.25, 3.3. 3.35, 3.4, 3.45, 3.5, 3.55, 3.6, 3.65, 3.7, 3.75, 3.8, 3.85, 3.9, 3.95, 4.0, 4.05, 4.1, 4.15, 4.2, 4.25, 4.3. 4.35, 4.4, 4.45, 4.5, 4.55, 4.6, 4.65, 4.7, 4.75, 4.8, 4.85, 4.9, 4.95, and 5.0.

Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. Thus, even if a particular data point within the range is not explicitly identified or specifically referred to, it is to be understood that any data points within the range are to be considered to have been specified, and that the inventor(s) possessed knowledge of the entire range and the points within the range.

As used herein, the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AAB, BBC, AAABCCCC, CBBAAA, CABABB, and so forth. The skilled artisan will understand that typically there is no limit on the number of items or terms in any combination, unless otherwise apparent from the context.

Throughout this application, the terms “about” or “approximately” are used to indicate that a value includes an inherent variation. As used herein the qualifiers “about” or “approximately” are intended to include not only the exact value, amount, degree, dimension, measurement, orientation, event, circumstance, parameter, or other qualified characteristic, but are intended to include some slight variations due to measuring error, manufacturing tolerances, observer error, and combinations thereof, for example. The term “about” or “approximately”, where used herein when referring to a measurable value such as an amount, a temporal duration, and the like, is meant to encompass, for example, variations of ±20% or ±10%, or ±5%, or ±1%, or ±0.1% from the specified value, as such variations are appropriate to perform the disclosed methods and as understood by persons having ordinary skill in the art.

As used herein, the term “substantially” means that the subsequently described value, amount, degree, dimension, measurement, orientation, event, circumstance or parameter, or other qualified characteristic completely occurs, or occurs to a great extent or degree. For example, the term “substantially” means that the subsequently described value, amount, degree, dimension, measurement, orientation, event, circumstance, or parameter or other qualified characteristic occurs at least 80% of the time, at least 90% of the time, at least 91% of the time, at least 92% of the time, at least 93% of the time, at least 94% of the time, at least 95% of the time, at least 96% of the time, at least 97% of the time, at least 98% of the time, or at least 99% of the time.

The terms “significant” and “significantly” when used non-statistically in reference to a quantitative reference measure, are defined as meaning at least 5% of a reference measure, or at least 10% of a reference measure, or at least 20% of a reference measure, or at least 30% of a reference measure, or at least 40% of a reference measure, or at least 50% of a reference measure, or at least 60% of a reference measure, or at least 70% of a reference measure, or at least 80% of a reference measure, or at least 90% of a reference measure, or at least 95% of a reference measure, including 100% of a reference measure.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Techniques, components, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

Where used herein, the pronouns “we” or “us” or the possessive determiner “our” are intended to refer to all persons involved in a particular aspect of the investigation disclosed herein and as such may include non-inventor laboratory personnel, assistants, technicians, collaborators and/or contributors who worked under the supervision of the inventor(s), and thus are not intended to represent an inventorship role by said laboratory personnel, assistants, technicians, collaborators, and/or contributors in any subject matter disclosed herein

The present disclosure will now be discussed in terms of several specific, non-limiting, examples and embodiments. The examples described below, which include particular embodiments, will serve to illustrate the practice of the present disclosure, it being understood that the particulars shown are by way of example and for purposes of illustrative discussion of particular embodiments and are presented in the cause of providing what is believed to be a useful and readily understood description of procedures as well as of the principles and conceptual aspects of the present disclosure.

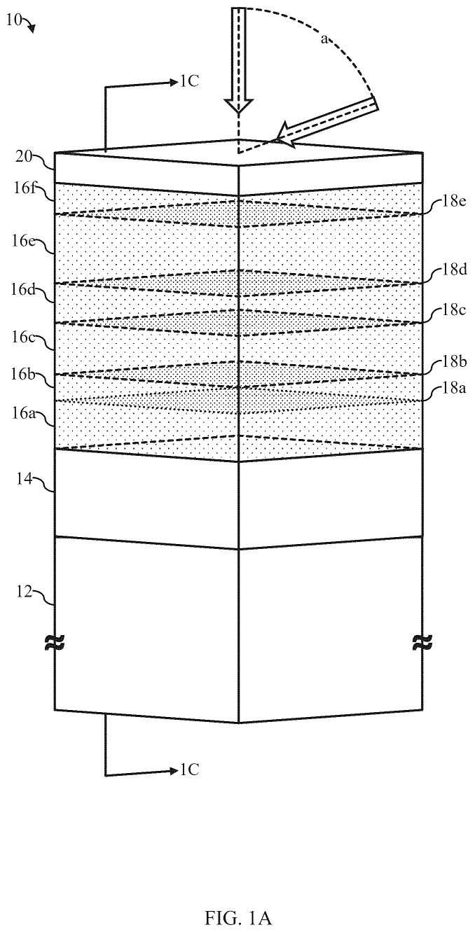

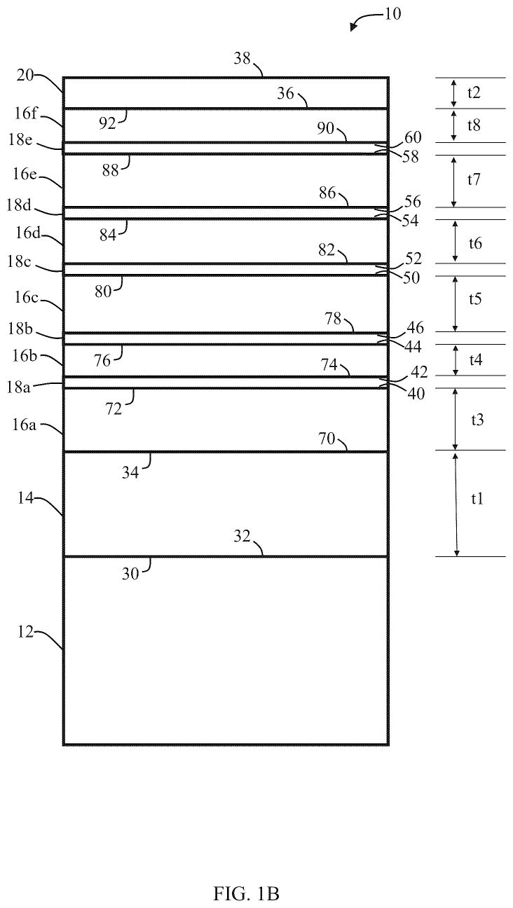

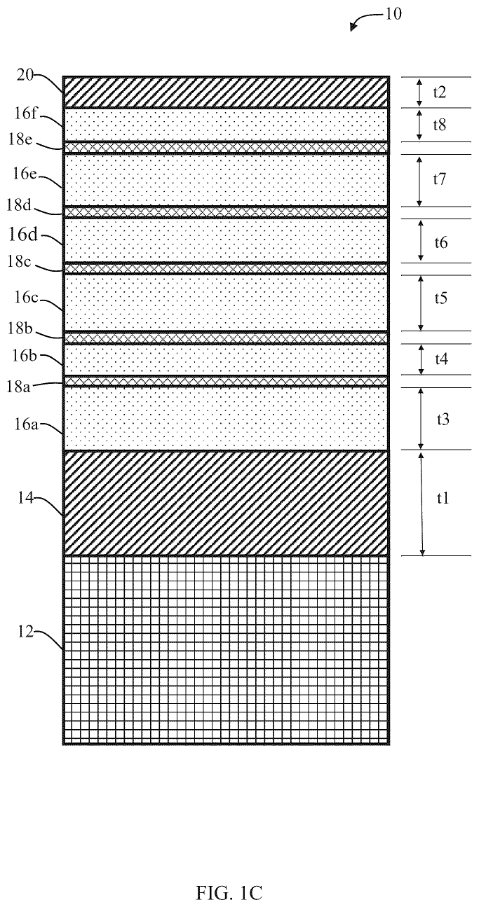

Turning now to FIG. 1A-1C, shown therein is an aperiodic absorber nanostructure 10 (which may be referred to herein simply as nanostructure 10) in accordance with the present disclosure. In general, the nanostructure 10 comprises a support substrate 12 comprised of gold, a first semiconductor absorber layer 14 in contact with the support substrate 12, a second semiconductor absorber layer 20, and a plurality of dielectric layers 16a-16n alternated with a plurality of graphene layers 18a-18n positioned between the first semiconductor absorber layer 14 and the second semiconductor absorber layer 20, wherein the thickness of each of the plurality of dielectric layers 16a-16n, the thickness of the first semiconductor absorber layer 14, and the thickness of the second semiconductor absorber layer 20, are configured in order for the nanostructure 10 to meet a desired absorption level of a predetermined infrared wavelength within a range of 3 μm to 5 μm.

The semiconductor absorber layer comprises a material that in at least certain embodiments has an optical constant tailored for strong absorption in the mid-infrared (3-5 μm), with a bandgap in the range of approximately 0.1-0.5 eV, corresponding to materials that efficiently absorb in this spectral window. The semiconductor absorber layer is intended to function synergistically with the graphene-dielectric stack to achieve perfect absorption and tunability. Non-limiting examples of semiconductor absorber layer materials which may be used herein include IV-VI semiconductors such as but not limited to lead selenide (PbSe), lead sulfide (PbS), lead telluride (PbTe), tin selenide (SnSe), and tin telluride (SnTe), and narrow-gap III-V compounds such as but not limited to indium antimonide (InSb) and gallium antimonide (GaSb).

The dielectric layer (a.k.a., “dielectric spacer”) functions to control optical interference and plasmonic coupling between adjacent layers, thereby tuning absorption in the 3-5 μm range. In a non-limiting embodiment, for the mid-infrared spectral range (3-5 μm), the dielectric material of the dielectric layer has a real refractive index (n) in a range of about 1.4 to about 2.2 and an extinction coefficient (k) in a range of about 0 to about 0.05. For example, in certain embodiments of the dielectric material, n is in a range of 1.4 to 2.2 and k is in a range of 0 to 0.05; or n is in a range of 1.5 to 2.1 and k is in a range of 0 to 0.04; or n is in a range of 1.6 to 2.0 and k is in a range of 0 to 0.03; or n is in a range of 1.7 to 1.9 and k is in a range of 0 to 0.02; or n is in a range of 1.7 to 1.85 and k is in a range of 0 to 0.01; or n is in a range of 1.725 to 1.8 and k is in a range of 0 to 0.01; or n is in a range of 1.75 to 1.8 and k is in a range of 0 to 0.005; or n is in a range of 1.75 to 1.8 and k is in a range of 0 to 0.0025; or n is in a range of 1.76 to 1.79 and k is in a range of 0 to 0.005; or n is in a range of 1.76 to 1.78 and k is in a range of 0 to 0.0025; or n is in a range of 1.76 to 1.78 and k is in a range of 0 to 0.002; or n is in a range of 1.76 to 1.78 and k is in a range of 0 to 0.001; or n is in a range of 1.765 to 1.775 and k is in a range of 0 to 0.001; or n is in a range of 1.765 to 1.775 and k is in a range of 0 to 0.0005. In one non-limiting embodiment, n=1.77 and k is in a range of 0 to 0.0005, i.e., k≈0.

In certain embodiments, the dielectric material may be comprise a polymer, an oxides, a nitrides, a fluorides, or a two-dimensional (2D) layered material. Particular examples include, but are not limited to, polyphenylsulfone (PPSU), tungsten disulfide (WS₂), silicon dioxide (SiO₂), aluminum oxide (Al₂O₃), and hexagonal boron nitride (h-BN).

The support substrate 12 may be comprised of a semi-infinite gold (Au), which inherently eliminates transmittance. The reflective properties of gold in the support substrate 12 augment the absorption capability of the plurality of graphene layers 18a-18n by creating a semi-mirror structure that enables the light to traverse the layers in the nanostructure 10 twice. The support substrate 12 may have a planar surface 30.

In a non-limiting embodiment, the first semiconductor absorber layer 14 and the second semiconductor absorber layer 20 are comprised of lead selenide (PbSe), which is a medium capable of absorbing mid-infrared light up to 4.4 μm. The deposit of the semiconductor absorber as a layer may be achieved through thermal evaporation.

The first semiconductor absorber layer 14 may have a first side 32 and a second side 34 opposing the first side 32. The first side 32 of the first semiconductor absorber layer 14 may be in contact with the planar surface of the support substrate 12. The first semiconductor absorber layer 14 has a first thickness t1.

The second semiconductor absorber layer 20 may have a first side 36 and a second side 38 opposing the first side 36. The second semiconductor absorber layer 20 has a second thickness t2.

In some implementations, the plurality of graphene layers 18a-18n may comprise a first graphene layer 18a having a first side 40 and a second side 42 opposing the first side 40, a second graphene layer 18b having a first side 44 and a second side 46 opposing the first side 44, a third graphene layer 18c having a first side 50 and a second side 52 opposing the first side 50, a fourth graphene layer 18d having a first side 54 and a second side 56 opposing the first side 54, and a fifth graphene layer 18e having a first side 58 and a second side 60 opposing the first side 58.

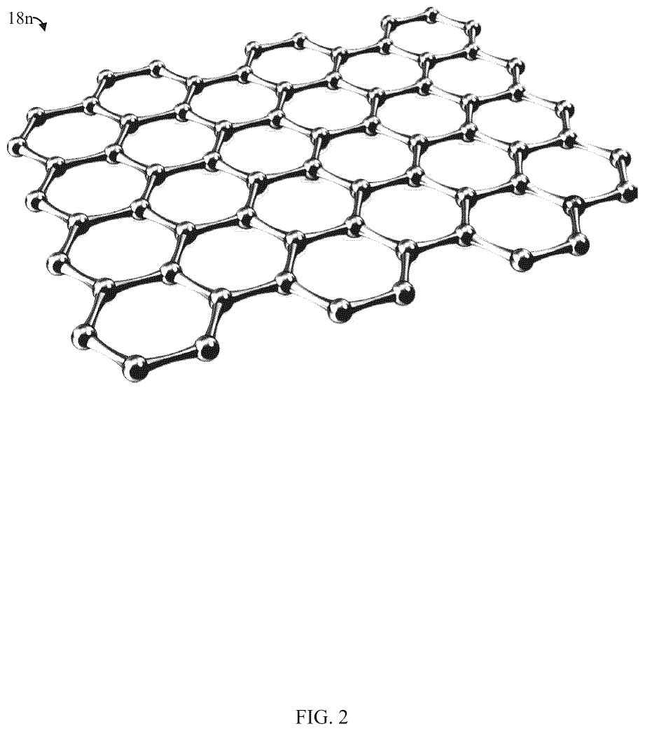

The graphene layers 18a-18n comprise graphene, which is a material well-known for its high electron mobility, optical transparency, flexibility, and adjustable conductivity, which efficiently captures incoming mid-IR electromagnetic wave. As illustrated in FIG. 2, graphene is a two-dimensional (2D) sheet comprising carbon atoms arranged in a hexagonal structure. Graphene has unique electrical, optical, and mechanical properties, which are well documented in the art. Graphene has high conductivity in the mid-IR and THz spectrums supporting surface plasmons.

The density of charge carriers linked to the chemical potential within the plurality of graphene layers 18a-18n can be controlled by applying a DC bias electric field perpendicular to the surfaces of graphene/dielectric. This results in the electrical manipulation of graphene's refractive index. An appropriate physical parameter for explaining the optical characteristics of graphene is optical conductivity, a complex number linked to the surface current induced in graphene by light, which significantly relies on the chemical potential (Fermi energy). The Kubo formula (Equation 1) can be employed to model the conductivity of graphene as follows:

$$σ ( ω , {μ}_{c} , Γ , T ) = - \frac{i {e}^{2} ( ω + i 2 Γ )}{π {ℏ}^{2}} [ \frac{1}{{( ω + i 2 Γ )}^{2}} {\int }_{0}^{∞} ( \frac{\partial {n}_{f} ( ϵ )}{\partial ϵ} - \frac{\partial {n}_{f} ( - ϵ )}{\partial ϵ} ) ϵ d ϵ - {\int }_{0}^{∞} \frac{{n}_{f} ( - ϵ ) - {n}_{f} ( ϵ )}{{( ω + i 2 Γ )}^{2} - 4 {( \frac{ϵ}{ℏ} )}^{2}} d ϵ ] \qquad ( Eqn 1 )$$

where n_{f}(∈)=1/{1+exp[(∈−μ_{c})/(k_{B}T)]} is Fermi-Dirac distribution, ω is radian frequency, e is the electron charge, ℏ is reduced Plank constant, T is the temperature, μ_{c} is the chemical potential, k_{B} is the Boltzmann constant,

$$Γ = e {v}_{F}^{2} / 2 {μ}_{c}$$

is the charge particle scattering, and V_{F}=10⁶ m/s is the Fermi velocity. The scattering rate for graphene in this context is realistic for multilayer structures, as confirmed by previously conducted relevant experiments.

The optical conductivity of graphene is divided into intraband and interband components, corresponding to absorption by free carriers and transitions from the valence band to the conduction band, respectively. In the mid-IR range, the contribution from intraband transitions becomes comparable to that of interband transitions. Consequently, control over intraband transitions, and thus the refractive index, can be achieved by adjusting the chemical potential in graphene.

As illustrated in FIGS. 1B-1C, in some implementations, the plurality of dielectric layers 16a-16n may comprise a first dielectric layer 16a having a third thickness t3, a second dielectric layer 16b having a fourth thickness t4, a third dielectric layer 16c having a fifth thickness t5, a fourth dielectric layer 16d having a sixth thickness t6, a fifth dielectric layer 16e having a seventh thickness t7, and a last dielectric layer 16f having an eighth thickness t8.

The first dielectric layer 16a may have a first side 70 and a second side 72 opposing the first side 70. The second dielectric layer 16b may have a first side 74 and a second side 76 opposing the first side 74. The third dielectric layer 16c may have a first side 78 and a second side 80 opposing the first side 78. The fourth dielectric layer 16d may have a first side 82 and a second side 84 opposing the first side 82. The fifth dielectric layer 16e may have a first side 86 and a second side 88 opposing the first side 86. The sixth dielectric layer 16f may have a first side 90 and a second side 92 opposing the first side 90.

The material used to make the plurality of dielectric layers 16a-16n may comprise a polymeric material having a thermal resilience such as a dielectric material mentioned above.

The interplay between the plurality of graphene layers 18a-18n and the plurality of dielectric layers 16a-16n supports surface plasmons at their interface, significantly contributing to the absorption mechanism.

In some implementations, the first side 70 of the first dielectric layer 16a of the plurality of dielectric layers 16a-16n may be in contact with the second side 34 of the first semiconductor absorber layer 14. Further, the first side 40 of the first graphene 18a layer may be in contact with the second side 72 of the first dielectric layer 16a, and the second side 42 of the first graphene layer 18a may be in contact with the first side 74 of the second dielectric layer 16b.

Likewise, continuing alternating the plurality of graphene layers 18a-18n and the plurality of dielectric layers 16a-16n, the first side 44 of the second graphene layer 18b may be in contact with the second side 76 of the second dielectric layer 16b, and the second side 46 of the second graphene layer 18b may be in contact with the first side 78 of the third dielectric layer 16c.

The first side 50 of the third graphene layer 18c may be in contact with the second side 80 of the third dielectric layer 16c, and the second side 52 of the third graphene layer 18c may be in contact with the first side 82 of the fourth dielectric layer 16d.

The first side 54 of the fourth graphene layer 18d may be in contact with the second side 84 of the fourth dielectric layer 16d and the second side 56 of the fourth graphene layer 18d may be in contact with the first side 86 of the fifth dielectric layer 16c.

The first side 58 of the fifth graphene layer 18e may be in contact with the second side 88 of the fifth dielectric layer 16e, and the second side 60 of the fifth graphene layer 18e may be in contact with the first side 90 of the last dielectric layer 16f.

The first side 36 of the second semiconductor absorber layer 20 may be in contact with the second side 92 of the last dielectric layer 16f.

In some implementations, the second side 38 of the second semiconductor absorber layer 20 may be in contact with air.

The position of each of the first semiconductor absorber layer 14, the plurality of dielectric layers 16a-16n, the plurality of graphene layers 18a-18n, and the second semiconductor absorber layer 20, remains constant in relation to the other layers (also referred to as the layer order). The combination of the layer order and the individual thicknesses t1-t8 of the layers determine where within the infrared wavelength range of 3 μm to 5 μm that the nanostructure 10 has near perfect absorption (that is, at least 99.99% absorption).

In use, the aperiodic absorber nanostructure 10 in accordance with the present disclosure has an absorption level of light at the predetermined infrared wavelength of at least 99.99%.

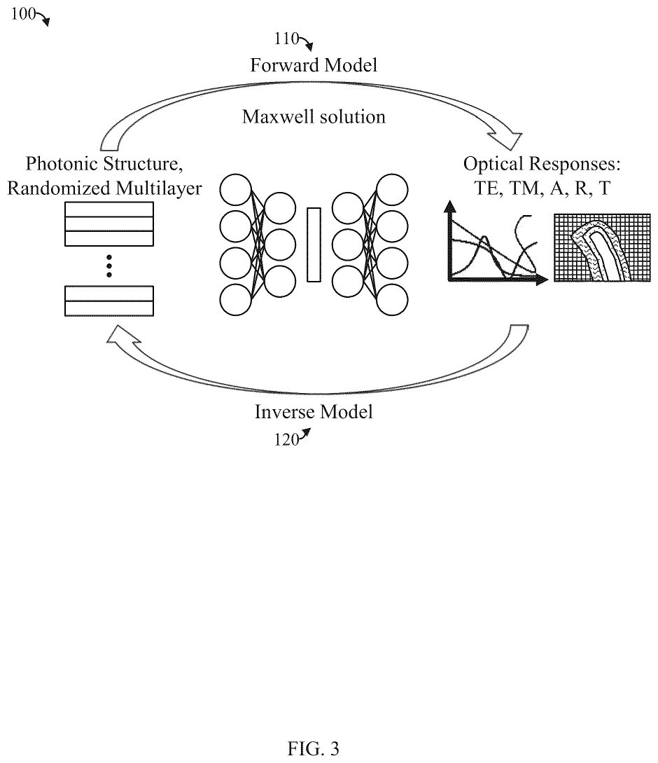

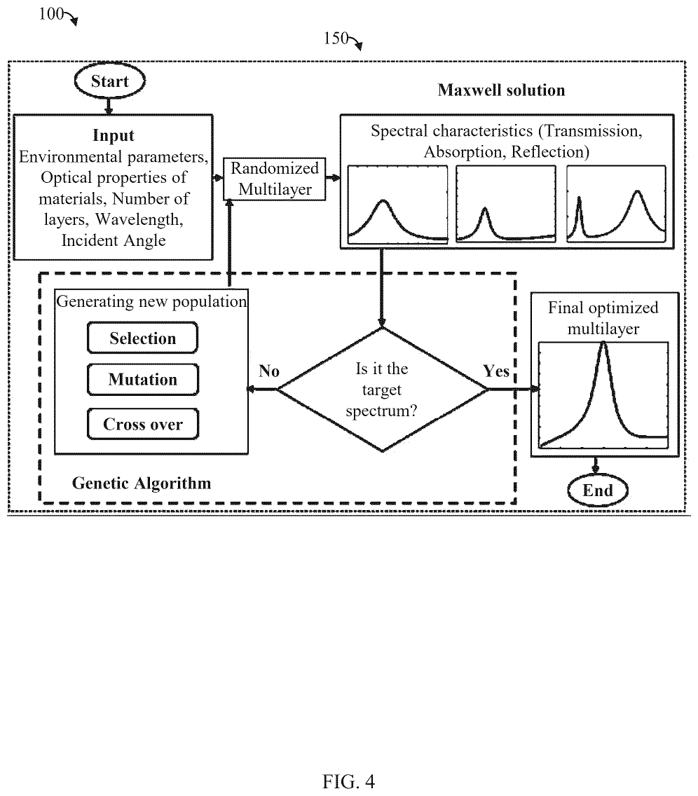

FIGS. 3 and 4 illustrate an exemplary method 100 for determining the first thickness t1 of the first semiconductor absorber layer, the second thickness t2 of the second semiconductor absorber layer, and the third, fourth, fifth, sixth, seventh, and eighth thicknesses t3-t8 of each of the plurality of dielectric layers 16a-16f, that are needed in order for the nanostructure to meet a desired absorption level of a predetermined infrared wavelength within a range of 3 μm to 5 μm.

The position of each of the first semiconductor absorber layer 14, the plurality of dielectric layers 16a-16n, the plurality of graphene layers 18a-18n, and the second semiconductor absorber layer 20, remains constant in relation to the other layers (also referred to as the layer order), while the individual thicknesses t1-t8 are changed, in order to tune the nanostructure 10 for absorption of the predetermined infrared wavelength within the range of 3 μm to 5 μm. The method 100 tunes the configuration of the nanostructure 10 (that is, determines the individual thicknesses t1-t8) to absorb the predetermined infrared wavelength by 0.25 μm intervals within the range of 3 μm to 5 μm.

As shown in FIG. 3, in a first portion 110 of the method 100, the optical response of randomized multilayers is obtained using a forward model, followed in a second portion 120 by the utilization of an inverse model to generate the optimized multilayers. As shown in FIG. 4, the optimization approach 150, integrating the Genetic Optimization Algorithm (GOA) and a local optimization algorithm, strategically refines aperiodic multilayer structures for optimal absorptance. The continuous cycle of stochastic initialization, population evolution, is visually elucidated, highlighting the commitment to maximizing absorptance through the lens of inverse design.

The flowchart depicted in FIG. 4 illustrates the iterative optimization cycle designed to explore the design space. The optimization process begins by generating a population of potential solutions, each distinguished by randomly assigned layer thicknesses. This stochastic initialization serves as the starting point for subsequent iterative optimization. Each iteration refines the solutions further, aiming to pinpoint aperiodic multilayer structures that increase the absorptance of the nanostructure 10. This iterative optimization process is designed to evolve the population towards superior solutions. The performance of each solution is rigorously evaluated by computing absorptance using the Transfer Matrix Method (TMM), which are well known in the art, and fitness scores are assigned based on these calculations to quantitatively measure their alignment with the overarching goal of maximizing absorptance. The genetic optimization algorithm systematically refines the populations through a sequence of selection, crossover, and mutation operations. This approach, inspired by natural selection, strategically favors solutions with higher fitness scores, introduces genetic diversity through crossover, and facilitates random changes through mutation. The iterative cycle continues until a defined convergence condition is met, resulting in the output of optimal layer thicknesses that decisively maximize the absorptance of the aperiodic multilayer structure at the desired wavelengths.

In parallel with the global genetic optimization algorithm, a local optimization algorithm operates, identifying the local optimum within the converged population. This simultaneous fine-tuning process refines the most optimal structure identified through inverse design principles. This innovative hybrid optimization approach, grounded in inverse design principles, underscores its efficacy in determining optimized layer thicknesses for aperiodic multilayer structures and achieving tunable perfect absorber nanostructures 10.

As noted, the hybrid optimization method mentioned above may be used to find the optimum thicknesses t1-t8 of the first semiconductor absorber layer 14, the plurality of dielectric layers 16a-16n, the plurality of graphene layers 18a-18n, and the second semiconductor absorber layer 20 to ensure that the absorbance of the nanostructure 10 approaches equality to the emittance for the desired infrared wavelength, where the desired infrared wavelength is in a range from 3 μm to 5 μm. In this non-limiting, case “perfect” absorption may be 99.99% or greater absorption.

The hybrid optimization method 100 used herein consists of a microgenetic global optimization algorithm coupled to a local optimization algorithm. It is well known that the local optimization algorithms find the local minima or maxima of a given set. It is also well known that the microgenetic algorithm avoids premature convergence and shows faster convergence to the near-optimal region compared with the conventional large population genetic algorithm, especially in multidimensional problems. Also, it is further well known that global optimization operations attempt to find the global minima or maxima of a given set.

As such, it is well understood by those skilled in the art that the hybrid genetic optimization method as used herein, which uses a microgenetic global optimization algorithm coupled to a local optimization algorithm, may be used to calculate the optimized thicknesses t1-t8 of the first semiconductor absorber layer 14, the plurality of dielectric layers 16a-16n, the plurality of graphene layers 18a-18n, and the second semiconductor absorber layer 20, for maximizing the absorption to the perfect value of unity at a prespecified wavelength and zero bias condition (μ=0 eV). The operation of a hybrid optimization method such as the one disclosed herein is well known and will not be discussed in detail herein for the sake of brevity.

It is understood by those skilled in the art that a microgenetic algorithm is an iterative optimization procedure which starts with a randomly selected population of potential solutions and gradually evolves toward improved solutions by applying the genetic operators which are patterned after the natural selection process. For the first semiconductor absorber layer 14, the plurality of dielectric layers 16a-16n, the plurality of graphene layers 18a-18n, and the second semiconductor absorber layer 20, the possible first through eighth thicknesses t1-t8 are evaluated according to the hybrid optimization method 100 disclosed herein. In one particular embodiment, the absorption of the graphene multilayer nanostructure 10 with a desired thickness is calculated to evaluate the level of optimization necessary to determine the optimal thickness of each of the first semiconductor absorber layer 14, the plurality of dielectric layers 16a-16n, the plurality of graphene layers 18a-18n, and the second semiconductor absorber layer 20.

In one implementation, the thickness t1-t8 of each of the first semiconductor absorber layer 14, the plurality of dielectric layers 16a-16n, the plurality of graphene layers 18a-18n, and the second semiconductor absorber layer 20, may be calculated simultaneously. Then, the hybrid optimization algorithm may proceed to iteratively generate a new population of thickness values by using the crossover, mutation, and selection operators to find the optimum thicknesses t1-t8 for the defined positions of each of the first semiconductor absorber layer 14, the plurality of dielectric layers 16a-16n, the plurality of graphene layers 18a-18n, and the second semiconductor absorber layer 20.

The method 100 and resulting aperiodic multilayer nanostructures 10 possess the capability to modulate the absorption peak across the entire mid-IR spectrum, achieving absorption peaks at any desired wavelength within the mid-IR range solely through adjustments in one or more of the thicknesses t1-t8 of the first semiconductor absorber layer 14, the plurality of dielectric layers 16a-16n, the plurality of graphene layers 18a-18n, and the second semiconductor absorber layer 20. Adjustments may be made such that the absorption peak is targeted in 0.25 μm increments within the 3 μm to 5 μm range.

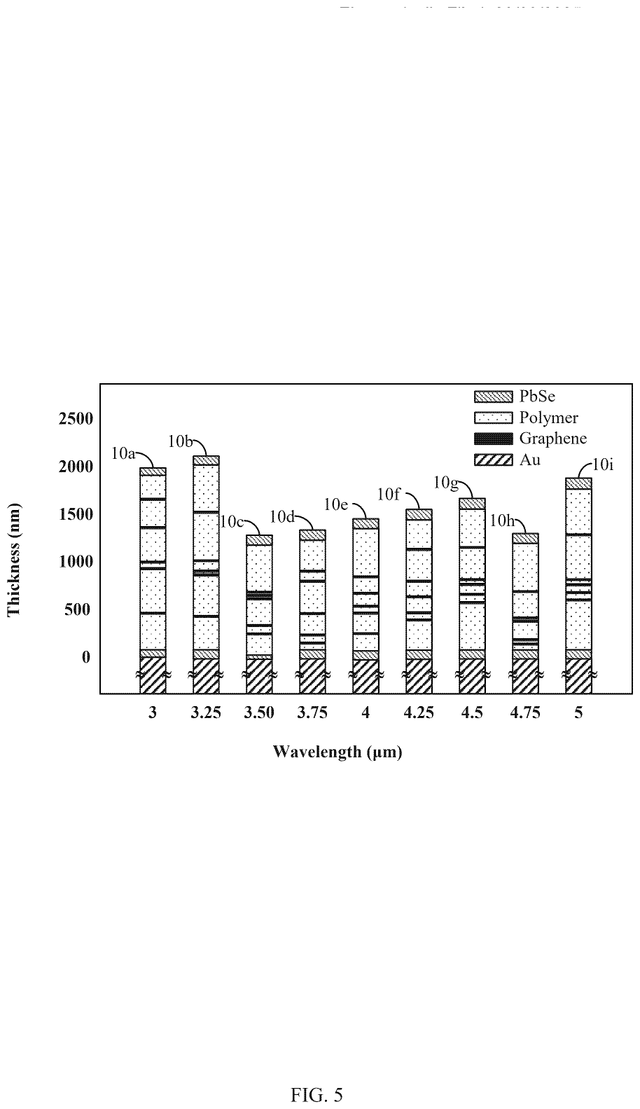

While the materials and number of layers remain consistent for all the nanostructures 10, the optimization algorithm defines the thickness of each layer to maximize absorption in the desired wavelengths, covering the atmospheric windows. FIG. 5 illustrates nine exemplary different nanostructures 10a-10i, which were precisely engineered by inverse design to achieve absorption peaks at a particular wavelength. These nanostructures 10a-10i stand out for their compact profiles, maintaining an overall thickness below 2 μm, while each exhibits a unique thickness profile. This variation in thickness plays a pivotal role in enabling the nanostructures 10 to selectively target light across different wavelengths. Through adjustments in layer thicknesses t1-t8, the absorptive properties of the nanostructures 10 are finely tuned, demonstrating the versatility and accuracy of the nanostructures 10 in handling a range of wavelengths. The specific thicknesses (in nm) of the various layers of the nanostructures shown in FIG. 5 are indicated in Table 1. In Table 1 the semiconductor absorber layer is designated as PbSe. It is to be understood that the thickness of the PA nanostructures of the present claims and disclosure are not to be limited to these specific thicknesses. For example, in non-limiting embodiments, the semiconductor absorber layer thicknesses may be in a range of from 50-110 nm, the dielectric layer thickness may be in a range of 20-500 nm, and the graphene layer thickness may be in a range of 0.25 nm to 0.40 nm.

TABLE 1
Examples of layer thicknesses* in specific PA nanostructures
in FIG. 5 according to target absorption window wavelengths.

Layer

| Materials | | | | | | | | | |
|---|---|---|---|---|---|---|---|---|---|
| from top to | Target wave-length | | | | | | | | |
| bottom | 3 μm | 3.25 μm | 3.5 μm | 3.75 μm | 4 μm | 4.25 μm | 4.5 μm | 4.75 μm | 5 μm |
| PbSe | 57.58 | 86.64 | 94.23 | 99.63 | 99.26 | 99.95 | 99.65 | 99.97 | 100 |
| Dielectric | 258.29 | 488.75 | 485.64 | 322.54 | 487.67 | 305.55 | 398.14 | 488.31 | 462.18 |
| Graphene | 0.33 | 0.33 | 0.33 | 0.33 | 0.33 | 0.33 | 0.33 | 0.33 | 0.33 |
| Dielectric | 293.94 | 477.02 | 26.75 | 97.11 | 165.07 | 311.11 | 317.76 | 268.22 | 455.6 |
| Graphene | 0.33 | 0.33 | 0.33 | 0.33 | 0.33 | 0.33 | 0.33 | 0.33 | 0.33 |
| Dielectric | 339.65 | 108.47 | 29.74 | 323.14 | 128.34 | 165.79 | 49.12 | 32.73 | 39.43 |
| Graphene | 0.33 | 0.33 | 0.33 | 0.33 | 0.33 | 0.33 | 0.33 | 0.33 | 0.33 |
| Dielectric | 56.9 | 30 | 263.67 | 219.76 | 62.17 | 155.33 | 103.81 | 178.83 | 90.88 |
| Graphene | 0.33 | 0.33 | 0.33 | 0.33 | 0.33 | 0.33 | 0.33 | 0.33 | 0.33 |
| Dielectric | 454.4 | 417.91 | 87.65 | 74.61 | 212.1 | 61.57 | 79.04 | 43.74 | 71.98 |
| Graphene | 0.33 | 0.33 | 0.33 | 0.33 | 0.33 | 0.33 | 0.33 | 0.33 | 0.33 |
| Dielectric | 356.52 | 337.26 | 203.12 | 64.44 | 167.94 | 297.17 | 465.53 | 49.28 | 486.23 |
| PbSe | 93.87 | 86.61 | 46.86 | 94.11 | 85.68 | 99.85 | 95.36 | 98.55 | 100 |

* = nanometers

In use, the predetermined infrared wavelength within the range of 3 μm to 5 μm may be chosen based at least in part on desired atmospheric windows absorption. For example, the preferred use may be within a blank window or within a filled window.

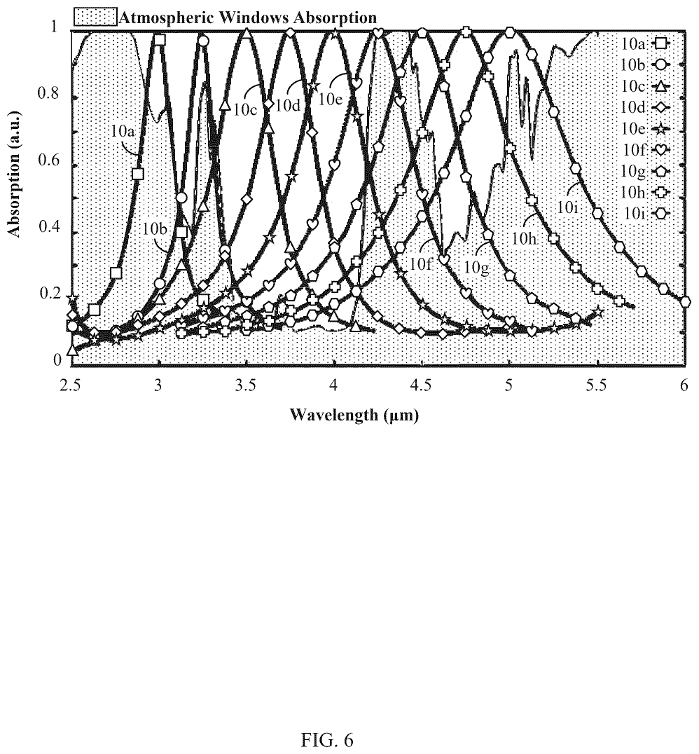

FIG. 6 shows the absorption spectra of the nine distinct nanostructures 10 labeled from 10a to 10i of FIG. 5, overlayed on an exemplary graph of atmospheric windows absorption. Each of the nanostructures 10a-10i shown is optimized for peak absorption at 3 μm, 3.25 μm, 3.5 μm, 3.75 μm, 4 μm, 4.25 μm, 4.5 μm, 4.75 μm, and 5 μm, respectively. Through the interaction of the incident light with the nanostructures 10a-10i, all the of the disclosed nanostructures 10a-10i exhibit almost perfect absorption at desired wavelengths.

To underscore the significance of the genetic optimization algorithm in designing the nanostructures 10, and elucidate the impact of layer thickness t1-t8 on absorption characteristics, a comparative analysis between optimized and non-optimized multilayer structures was performed as explained below.

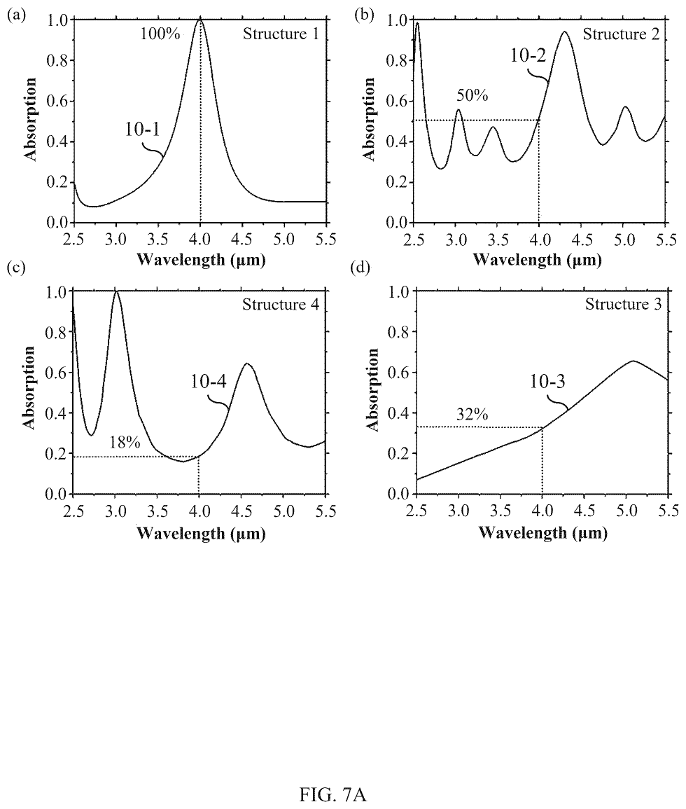

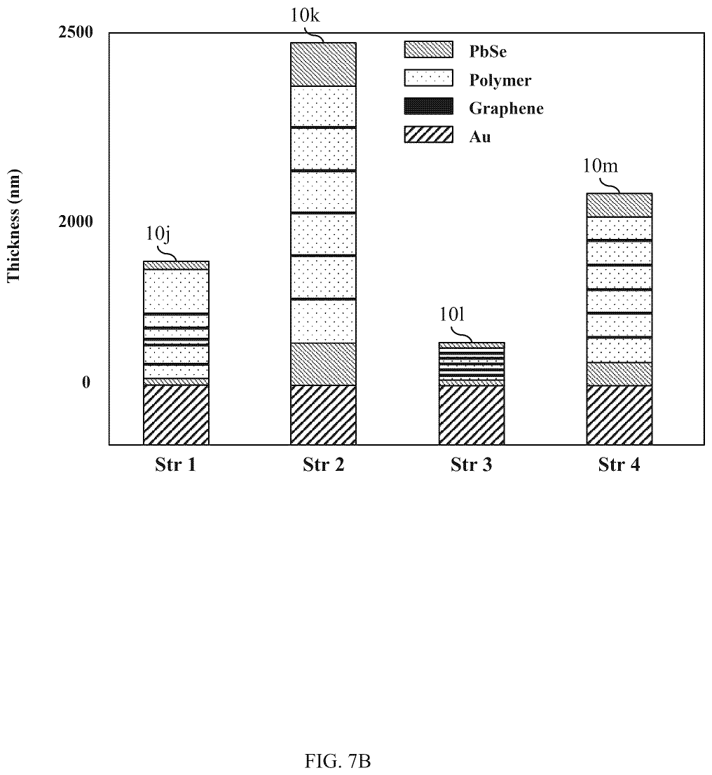

To demonstrate the effectiveness of the disclosed optimization algorithm in designing high-performance absorbers and to clucidate the critical role of layer thickness in shaping absorption characteristics, we performed a detailed comparative analysis between optimized and non-optimized multilayer structures, as shown in FIG. 7A (a-d). Structure 1, optimized using inverse design, achieves a sharp and precise absorption peak at 4 μm. In contrast, Structures 2, 3, and 4 use uniform, non-optimized layer thicknesses derived from the optimized design: the maximum thickness (487.67 nm), minimum thickness (62.17 nm), and average thickness (274.92 nm) of Structure 1, respectively. These non-optimized designs exhibit significant deviations in absorption peak position and substantially lower absorption efficiency compared to the optimized structure. The absorption peaks for Structures 2, 3, and 4 are shifted away from 4 μm, with broader and less efficient profiles, emphasizing the critical importance of precise layer thickness control. The non-optimized Structures 2-4 represent varying layer thicknesses t1-t8 in the nanostructure 10 of FIGS. 1B-1C.

FIG. 7B is a schematic of the material layer distributions in each structure in FIG. 7A. Thicknesses are not necessarily to scale. While the material sequence and composition are kept constant, only the optimized, aperiodic thickness profile in Structure 1 enables impedance matching and constructive interference, which are required for near-unity absorption. These results strongly validate the necessity of the inverse design optimization algorithm (method 10) in engineering high-performance multilayer absorbers with tailored spectral responses.

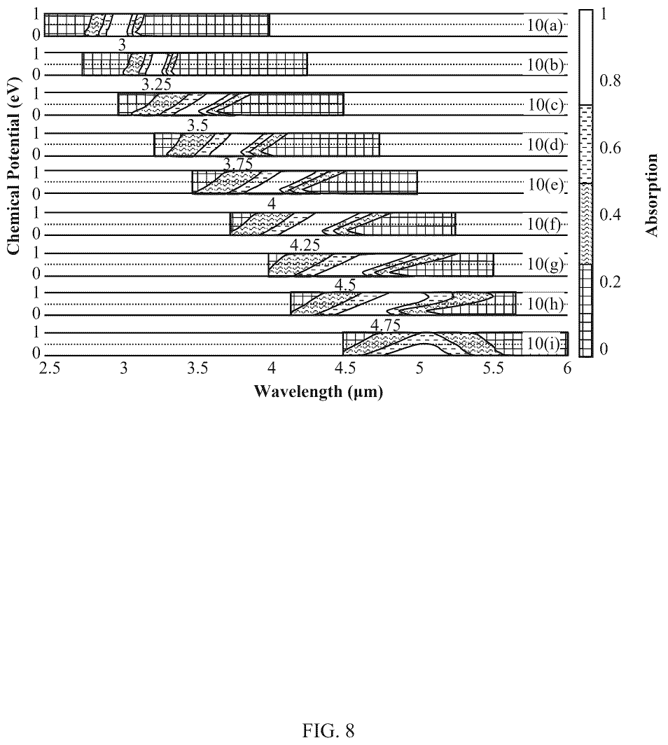

To illustrate the dynamic tunability and switchability in the design of the nanostructure 10 design, the impact of varying chemical potentials on the plurality of graphene layers 18a-18n within the nanostructure 10 is shown in FIG. 8. More specifically FIG. 8 depicts the absorption spectra of nine optimized nanostructures 10(a)-10(i) as a function of the chemical potentials. For the first and second nanostructures 10(a) and 10(b), an elevation in the chemical potential from 0 eV to 1 eV results in a shift of the absorption peak from 3 μm to 3.05 μm and from 3.25 μm to 3.29 μm, respectively. Consequently, the interplay of the absorption of the alternated graphene layers and dielectric layers and the absorption of the first and second semiconductor absorber 14, 20, contributes to tunability, showcasing outstanding and nearly flawless absorption characteristics in these specific wavelengths. The average contribution of the plurality of graphene layers 18a-18n to absorption in these nanostructures 10 hovers around 20%, with the first and second semiconductor absorber layers 14, 20 predominantly responsible for the majority of absorption. When comparing these results with those of the other optimized nanostructures 10(c), 10(d), 10(e), 10(f), 10(g), and 10(h) depicted in FIG. 8, it is evident that the impact of varying chemical potential on absorption peaks is more notable at longer wavelengths. This highlights the substantial tunability and switchability of the nanostructures 10, suggesting a significant contribution from the graphene layers to the absorption rate. For instance, the fifth nanostructure 10(e), optimized specifically for peak absorption at 4 μm, illustrates the dynamic tunability of the nanostructure 10: at a chemical potential of 0 eV, it achieves perfect absorptance (unity) at 4 μm. With an increase in the chemical potential to 1 eV, the peak absorptance shifts to 4.22 μm while maintaining a high absorptance of 0.9. This highlights remarkable capability to sustain high absorption efficiency while demonstrating a noticeable tunability range of the nanostructures 10.

The switchable characteristic of the nanostructure 10 is exemplified by modulating perfect absorption through variations in chemical potential at the optimized wavelength. Specifically, as one example, the fifth nanostructure 10(c), optimized for a peak absorption at 4 μm, substantial switchability is observed: transitioning from a chemical potential of 0 eV to 1 eV results in a decrease in absorption at 4 μm from 100% to 56%, emphasizing its notable switchable behavior. The optimized ninth nanostructure 10(i) further illustrates this switchability, demonstrating a significant shift. Remarkably, the perfect absorptance, initially achieving unity at 5 μm with a chemical potential of zero, can be adjusted to an absorptance of 0.55 by changing the chemical potential to 1 eV. This underscores the practicality of designing the nanostructures 10 that are both tunable and switchable as PAs. Previous research has shown that switchability is enhanced by adding more graphene layers 18. Although the nanostructure 10 incorporate a relatively modest number of graphene layers 18 in the implementation in which the nanostructure 10 has five graphene layers 18a-18e, the nanostructures 10 still manifest significant switchability, demonstrating the effectiveness of the nanostructures 10 in achieving dynamic control over absorption properties.

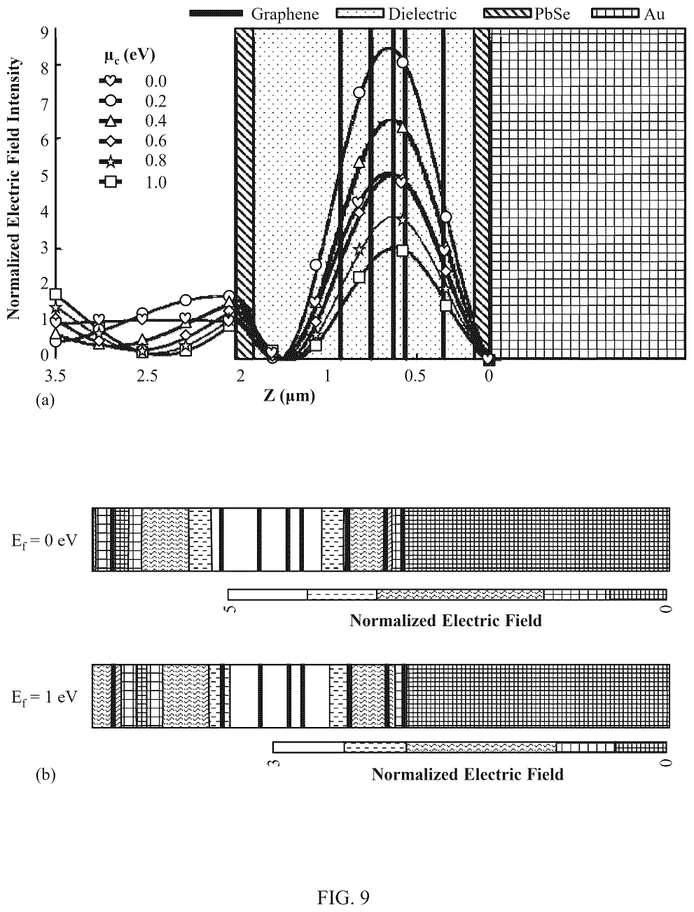

To gain deeper insight into the absorption behavior and tunability of our structure, we analyzed the electric field distribution under different values of graphene chemical potential (uc). FIG. 9 presents a combined visualization of simulation results from FDTD and COMSOL Multiphysics, highlighting the evolution of electric field intensity with μc. FIG. 9(a) shows the normalized electric field intensity along the z-direction, including the air region, dielectric layers, graphene sheets, and gold substrate. This plot, simulated using FDTD, captures how the field is redistributed across the structure for μc ranging from 0 to 1 eV. At μc=0 eV, where the structure is optimized for maximum absorption, we observe a flat and nearly constant electric field in the air region, indicating excellent impedance matching and minimal reflection. The strong field confinement inside the multilayer also suggests high absorptance. Interestingly, as μc increases, the electric field intensity inside the structure does not monotonically decrease. Instead, the peak field shifts in location and magnitude, reflecting changes in the internal mode structure and plasmonic response. However, this variation does not directly indicate improved absorption—rather, it reflects altered resonance conditions. Importantly, the non-flat air region field profiles at higher μc values indicate increased reflection and reduced absorption, consistent with the switching effect. To further validate these findings, FIG. 9(b) presents 2D electric field maps simulated using COMSOL Multiphysics for two representative chemical potentials: μc=0 eV (top) and μc=1 eV (bottom). At μc=0 eV, the field is strongly confined within the multilayer, while at μc=1 eV, the field penetration is significantly weaker—supporting the observation that electrical modulation of μc suppresses absorption. Together, these results show that perfect absorption is achieved through both impedance matching (zero reflection) and effective field localization, and that the structure's switching capability arises from the modulation of graphene's optical conductivity, which alters its ability to support resonant plasmonic modes.

In our optimized structure, it is also crucial to evaluate the sensitivity to fabrication errors and the tolerance range to ensure practical applicability. To address this, we analyze the impact of fabrication tolerances by varying the thickness of the thinnest layer by ±5%. The original, optimized structure achieves 100% absorption at 3.991 μm, while the structures with +5% and −5% thickness variations exhibit 100% absorption at 4.002 μm and 3.988 μm, respectively. This demonstrates a wavelength shift of +0.011 μm for a +5% error and −0.003 μm for a −5% error.

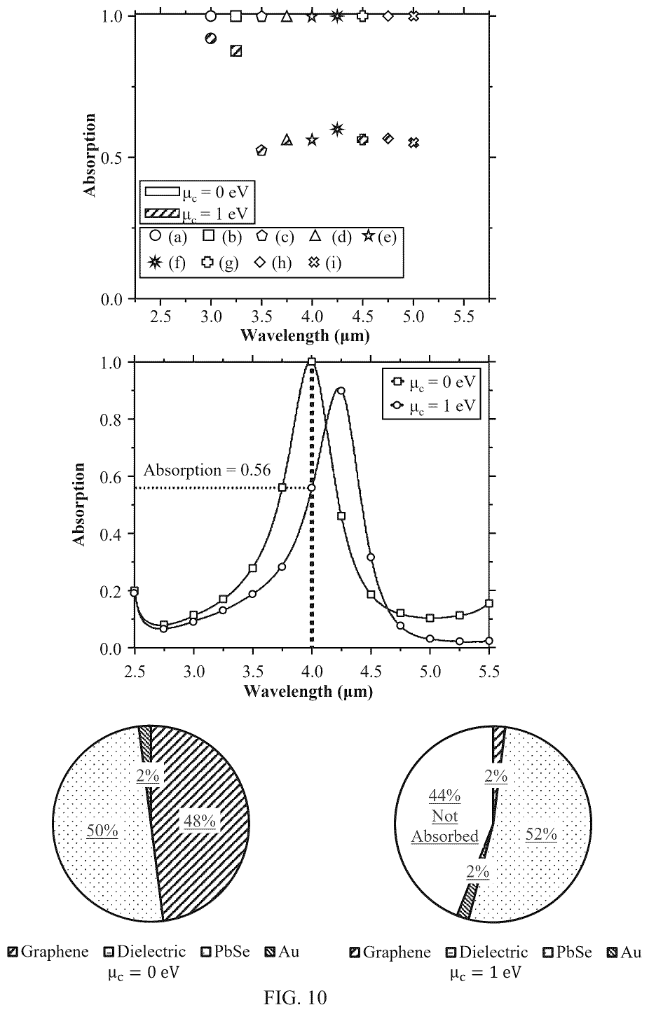

As noted, the structures 10c-10h, which were optimized for longer wavelengths, exhibit a more substantial change in absorption intensity and redshift under varying μc. This is particularly evident for designs targeting wavelengths of 3.5 μm and higher, where the absorption efficiency drops by up to 50%, as illustrated in FIG. 10(a) These changes can be attributed to the tunable optical conductivity of graphene, as described by the Kubo formula (Equation 1). As μc increases, intraband transitions in graphene become more dominant, leading to a rise in carrier density. This, in turn, increases the plasma frequency, thereby altering the resonance conditions within the multilayer structure. Simultaneously, the effective refractive index of the graphene layers increases, while the imaginary part of the permittivity decreases, resulting in weaker plasmonic confinement and a corresponding reduction in absorption efficiency.

The absorption spectrum of the structure optimized at 4 μm is shown in FIG. 10(b), where increasing the chemical potential from 0 eV to 1 eV reduces the peak absorption from 100% to 56%. This amplitude modulation is directly tied to a redistribution of absorption among the constituent materials, as detailed in FIG. 10(c). There, the absorption contribution of each material is shown for both μc=0.0 eV and μc=1.0 eV. Notably, at μc=0.0 eV, graphene layers contribute 48% to the total absorption, while PbSe absorbs the majority of the remainder. However, when μc increases to 1.0 eV, graphene's contribution drops sharply to just 2%, and 44% of the incident energy is no longer absorbed, highlighting the absorber's electrical switchability. This behavior stems from the fact that the energy absorbed in the multilayer structure is influenced by the effective refractive index, which itself depends on the chemical potential of graphene. The observed shift in absorption characteristics confirms the feasibility of creating electrically reconfigurable optical absorbers, in which both amplitude and material-selective absorption can be dynamically tuned.

The observed modulation in absorption amplitude and material contribution highlights the potential of this structure as a reconfigurable mid-IR absorber. The ability to dynamically control absorption via chemical potential—without modifying the physical structure—enables practical applications in adaptive filtering, tunable sensing, and programmable thermal emission systems.

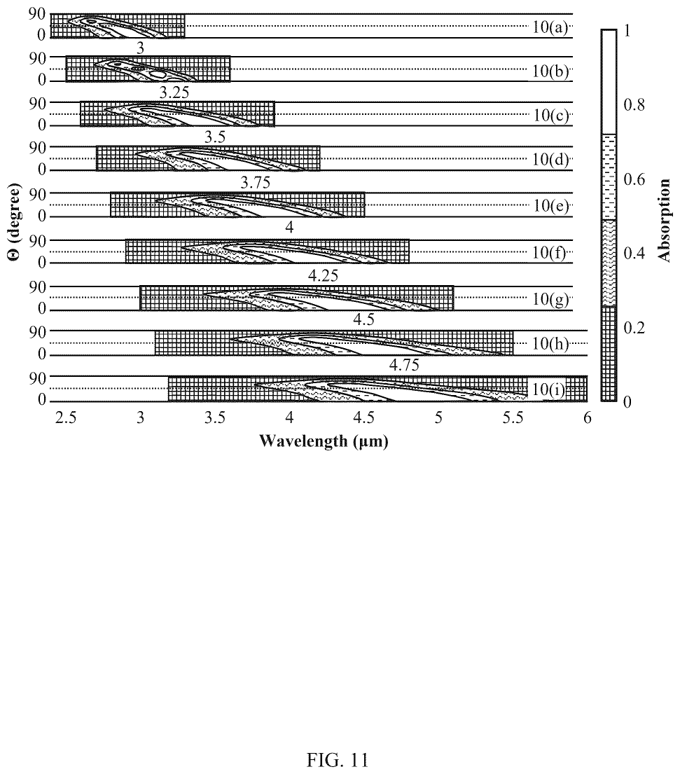

FIG. 11 illustrates an overview of absorption spectra of the nanostructure 10 at various incident angles of light, spanning from θ=0° (normal incidence) to θ=90° (grazing incidence), for all the nanostructures 10 designed to absorb within the 3 μm to 5 μm range, with 0.25 μm intervals. This analysis reveals an interesting characteristic: as the incident angle increases, there is a noticeable shift in the absorption peaks towards shorter wavelengths. Despite these shifts, the nanostructures 10 demonstrate remarkable resilience in maintaining high absorption levels. The absorption rate exceeds 90%, even at incident angles as steep as approximately 46, 47, 49, 50, 52, 55, 57, 58, and 60 degrees for the nine exemplary nanostructures 10(a), 10(b), 10(c), 10(d), 10(e), 10(f), 10(g), 10(h), and 10(i) respectively. These findings hold importance as they validate the robustness and applicability of the design of the nanostructures 10. The capacity to maintain nearly perfect absorption across a broad range of incident angles not only underscores the effectiveness of the nanostructures 10, but also underscores the suitability of the nanostructures 10 for practical applications, where light commonly approaches from diverse angles.

In use of the aperiodic absorber nanostructure 10, when an incident angle a of light at the predetermined infrared wavelength is between zero degrees and fifty-two degrees to the nanostructure 10 (as shown in FIG. 1A), the absorption level of light at the predetermined infrared wavelength is over 90%.

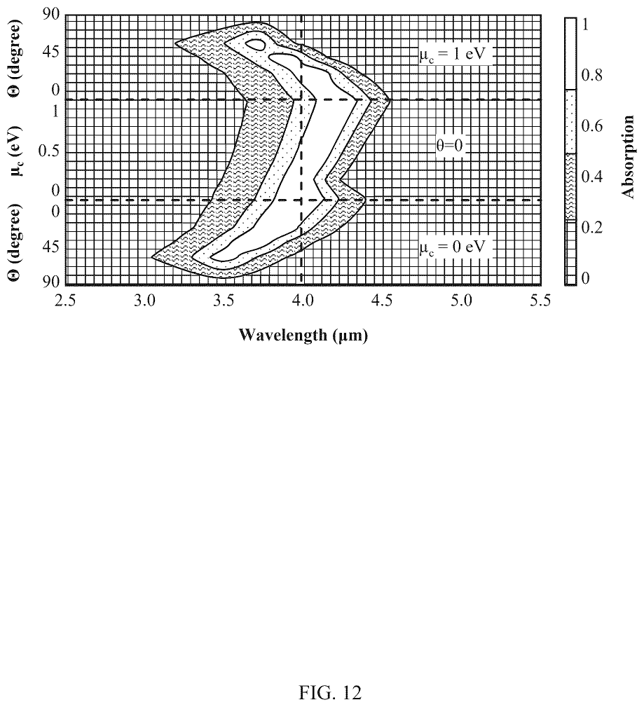

To illustrate the inherent controllability and tunability of the nanostructures 10, the effect of varying chemical potential and incident angle on the fifth nanostructure 10(e) is shown in FIG. 12. This highlights how changes in chemical potential and incident angle influence the absorptive capacity of this structure, optimized for peak absorption at 4 μm. FIG. 12 provides a clear visualization of the dynamic adjustability of the nanostructure 10, showing that altering the chemical potential from 0 eV to 1 eV shifts the absorption peak at λ=4 μm towards higher wavelengths under normal incidence while varying the incident angles for constant chemical potentials causes the absorption peak to shift towards lower wavelengths. Nevertheless, it is evident that alterations of both chemical potential and incident angle lead to a decline in absorption performance. Despite this, the nanostructure 10(e) maintains a high absorption peak above 0.9 for angle adjustments up to 52 degrees. The absorption peak of the nanostructure 10(e) can be tuned from λ=4 μm to λ=4.22 μm by varying the chemical potential from 0 eV to 1 eV. Remarkably, there is substantial switchability, resulting in a decrease in absorption at 4 μm from 100% to 56% during the transition from 0 eV to 1 eV. The nanostructure 10(c) still has more than 90% absorption by adjusting the angle up to 52°. Changing chemical potential and incident angle at the same time results in a deterioration of absorption performance. This demonstrates the nanostructure 10 capability to function as a near-PA in practical situations where light incidence angles can vary.

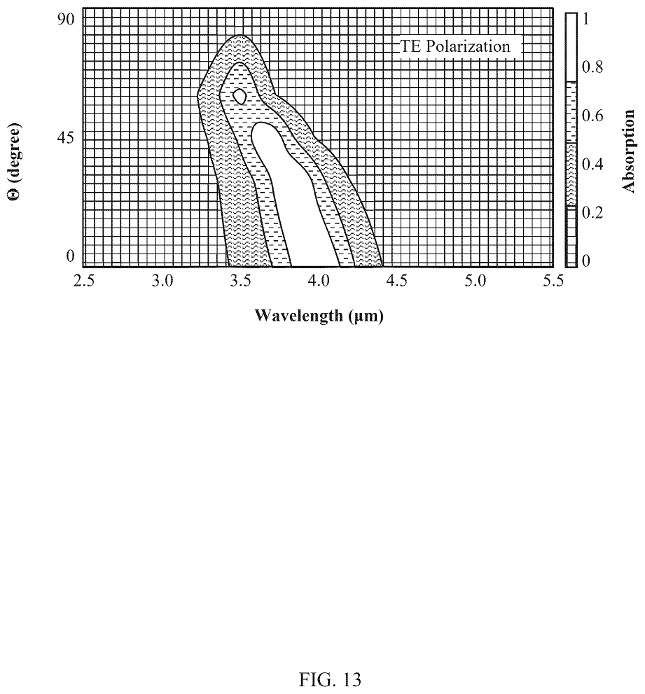

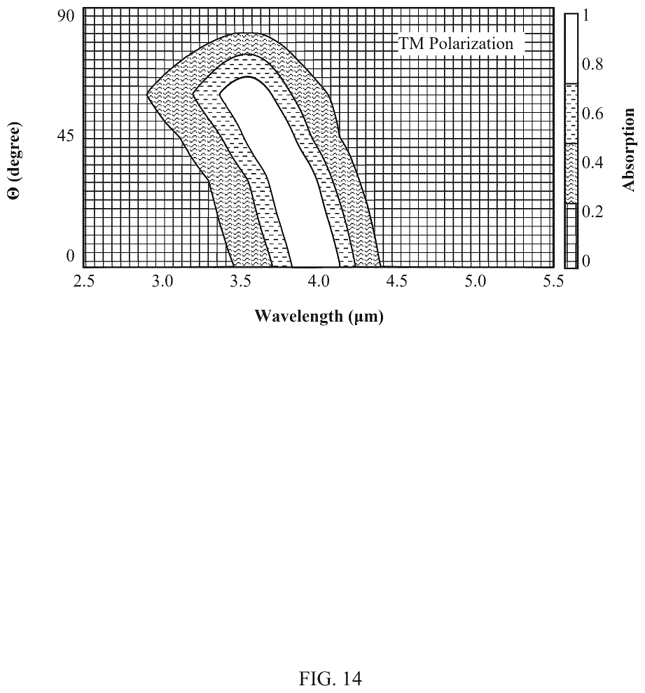

FIGS. 13 and 14 illustrates the absorption spectrum for both TE and TM polarizations, showcasing the impact of varying the incident angle for the fifth nanostructure 10(e). It is evident that the absorption performance is superior for TM polarization compared to TE polarization. The fifth nanostructure 10(e) can operate close to a PA with 90% absorption, allowing adjustments in the angle up to 60 degrees for TM polarization, while reaching a limit of 47 degrees for TE polarization. This difference underscores the structure's ability to handle a wider range of incident angles effectively when the magnetic component of the light is more engaged (TM polarization), providing greater flexibility in applications where the angle of incidence cannot be precisely controlled.

A method of production of the nanostructure 10 may comprise determining the first through eighth thicknesses t1-t8 of each of the first semiconductor absorber layer 14, the plurality of dielectric layers 16a-16n, the plurality of graphene layers 18a-18n, and the second semiconductor absorber layer 20, such that the nanostructure 10 meets a desired absorption level of a predetermined infrared wavelength within a range of 3 μm to 5 μm, by, iteratively applying a micro-genetic optimization algorithm; and then constructing the aperiodic absorber nanostructure 10 based on the determined thicknesses t1-t8. In some implementations, the first through eighth thicknesses t1-t8 may be provided by a pre-production step of determination.

Constructing the aperiodic absorber nanostructure 10 using the determined first through eighth thicknesses t1-t8 of each of the first semiconductor absorber layer 14, the plurality of dielectric layers 16a-16n, the plurality of graphene layers 18a-18n, and the second semiconductor absorber layer 20, may comprise: layering the first semiconductor absorber layer 14 on the support substrate 12, such that the first side 32 of the first semiconductor absorber layer 14 is in contact with the planar surface 30 of the support substrate 12; layering the first dielectric layer 16a of the plurality of dielectric layers 16a-16n on the first semiconductor absorber layer 14, such that the first side 70 of the first dielectric layer 16a is in contact with the second side 34 of the first semiconductor absorber layer 14; alternating layering the plurality of graphene layers 18a-18n with remaining ones of the plurality of dielectric layers 16b-16n, starting with the first graphene layer 18a of the plurality of graphene layers 18a-18n and ending with a last dielectric layer 16n of the plurality of dielectric layers 16a-16n; and layering the second semiconductor absorber layer 20 on the last dielectric layer 16f, such that the first side 36 of the second semiconductor absorber layer 20 is in contact with the second side 92 of the last dielectric layer 16f.

In certain non-limiting implementations, the first semiconductor absorber layer 14 and/or the second semiconductor absorber layer 20 may be deposited using thermal evaporation.

In some implementations, constructing the nanostructure 10 may further comprise, layering the first graphene layer 18a such that the first side 40 of the first graphene layer 18a is in contact with the second side 72 of the first dielectric layer 16a and the second side 42 of the first graphene layer 16a is in contact with the first side 74 of the second dielectric layer 16b; layering the second graphene layer 18b such that the first side 44 of the second graphene layer 18b is in contact with the second side 76 of the second dielectric layer 16b and the second side 46 of the second graphene layer 18b is in contact with the first side 78 of the third dielectric layer 16c; layering the third graphene layer 18c such that the first side 50 of the third graphene layer 18c is in contact with the second side 80 of the third dielectric layer 16c and the second side 52 of the third graphene layer 18c is in contact with the first side 82 of the fourth dielectric layer 16d; layering the fourth graphene layer 18d such that the first side 54 of the fourth graphene layer 18d is in contact with the second side 84 of the fourth dielectric layer 16d and the second side 56 of the fourth graphene layer 18d is in contact with the first side 86 of the fifth dielectric layer 16e; and layering the fifth graphene layer 18e such that and the first side 58 of the fifth graphene layer 18e is in contact with the second side 88 of the fifth dielectric layer 16e and the second side 60 of the fifth graphene layer 18e is in contact with the first side 90 of the last dielectric layer 16f.

As discussed above, perfect absorbers and methods for making perfect absorbers are needed for crafting tunable and switchable PAs within the mid-IR spectrum (3-5 μm). The present disclosure addresses these deficiencies by employing graphene-based nanophotonic aperiodic multilayer structures optimized through a micro-genetic optimization algorithm (GOA) in an inverse design framework, effectively addressing the challenges associated with designing PAs for multilayer structures targeting specific wavelengths. Genetic Optimization Algorithms are utilized, enabling precise engineering of layer thicknesses, facilitating the absorption of any desired wavelength, and navigating optimization complexities within multilayer optical systems.

It should be noted that considerations such as thermal and chemical stability during device operation are recognized. Depending on the chosen dielectric and semiconductor absorber, the layer thicknesses thereof may be re-optimized using the inverse design algorithm disclosed herein to achieve perfect absorption.

By meticulously controlling the atmospheric window within the 3-5 μm range through the design of nanostructures 10 that efficiently absorb light in this specific spectral band, applications reliant on mid-infrared technology may greatly benefit. This capability enhances the adaptability and effectiveness of the nanostructures 10 in real-world scenarios. The distinctive features of the nanostructures 10 includes exceptional tunability and switchability, achieved by manipulating the chemical potential of graphene through the application of various bias voltages. This adaptability in manipulating wavelengths and absorptance signifies a substantial advancement in mid-IR absorber technology. Furthermore, the nanostructures 10 exhibit remarkable adaptability to varying incident angles, maintaining high absorption efficiency up to 60 degrees. The nanostructures 10 and methods for making the nanostructures 10 described provide a framework for future advancements in mid-IR photonic applications. Striking a balance between material efficiency and functional versatility, this work contributes significantly to the field, opening avenues for innovative applications in mid-infrared technology.

A comprehensive comparison of recent mid-IR absorbers, including multilayer, metasurface, and graphene-based designs, is presented in Table 2. This comparison highlights the advantages of the presently disclosed novel structure in achieving near-unity absorption across a wide wavelength range, with dynamic tunability, electrical switchability, and angular stability, all within a compact ˜2 μm footprint. Unlike many prior approaches, the presently disclosed structure avoids lithographic patterning or full structural redesign, offering a fabrication-friendly and scalable solution.

TABLE 2
Comparisons of performance of prior graphene-based absorber in mid-IR and present structure.

| Structure | | | | | | | |
|---|---|---|---|---|---|---|---|
| Type (Cited | Operation | | Absorption | | | | Angle |
| References) | Wavelength | | % | Thickness | | Tunability and Switchability | independent |
| Graphene | 5-7 | μm | >99% | ~600 | nm | >99% absorption at 6.9 μm to | Not |
| Metasurface (1) | | | | | | 95% at 6.5 μm by Changing | reported |
| | | | | | | gate voltage 0-10 V | |
| Nanopatterned | 8-12 | μm | Up | ~1.8 | μm | ~40% absorption at 9.46 μm | Up to ~50° |
| Graphene (2) | | | to ~90(Nano- | | | to 60% at 8.33 μm(hole) 80% | |
| | | | hole) | | | absorption at 9.07 μm to 90% | |
| | | | Up to ~60 | | | at 8.73 μm(disk) by varying | |
| | | | (Nanodisk) | | | the chemical potential | |
| | | | | | | from −0.55 eV to −1 eV | |
| Graphene | 9.12 | um | 97.12% | ~1.2 | μm | 97.12% absorption at 9.12 μm | Not |
| Metamaterial | | | | | | to 60% at 11.3 μm by | reported |
| (3) | | | | | | Changing Chemical potential | |
| | | | | | | from 0.55 eV to 0.35 eV | |
| Graphene on | 5-10 | um | 90% | ~70 | nm | 90% absorption at 6.28 μm to | Up to ~45° |
| Au-grating (4) | | | | | | 90% at 6.22 μm by Changing | (absorption |
| | | | | | | gate voltage 0-1.6 V | 85%) |
| Multilayer (5) | 4.3-30 | μm | >99% | ~70 | μm | Not tunable | Up to ~60° |
| Multilayer (6) | 7.5-20 | μm | >95% | ~8 | μm | Not tunable | Up to ~80° |
| | | | | | | | (wide-angle) |
| Multilayer | 3-5 | μm | 98.57% | ~1.5 | μm | Not Tunable | Up to ~60° |
| with Ti Ring | | | | | | | |
| embedded (7) | | | | | | | |
| Multilayer (8) | 3-5 | um | 88.2% | ~850 | nm | Not Tunable | Angle- |
| | | | | | | | insensitive |
| Multilayer (9) | 2-8.41 | | 85% | ~3.75 | um | Not Tunable | Up to 50° (TE), |
| | | | | | | | Up to 70° (TM) |
| Multilayer (10) | 8-12 | um | >99.9% | ~1.44 | um | Not Tunable | Up to 45° |
| | | | (dual), >80% | | | | (dual), 30° |
| | | | (broadband) | | | | (broadband) |
| Multilayer | 3-5 | um | >99.9% | ~2 | um | >99.9% absorption at 4 um to | Up to 52° |
| (The present | | | | | | 95% absorption at 4.22 um by | |
| disclosure) | | | | | | changing chemical potential | |
| | | | | | | from 0 eV to 1 eV 100% | |
| | | | | | | absorption at 5 um to 56% | |
| | | | | | | absorption by changing chemical | |
| | | | | | | potential from 0 eV to 1 eV | |

The present disclosure introduces a novel graphene-based perfect absorber design operating in the mid-IR spectrum (e.g., 3-5 μm), offering exceptional tunability, angular robustness, and switchability. The present disclosure advances the concept of graphene-based aperiodic multilayer structures by describing a narrowband PA design that achieves exceptional tunability and precision. Unlike traditional approaches that require distinct designs for each wavelength by altering material order or complex redesigns, the disclosed structure maintains a fixed material sequence while tuning only the layer thicknesses to control the absorption peak. This novel design enables systematic absorption peak shifts across the broad 3-5 μm wavelength range, with 0.25 μm resolution, without compromising performance. The disclosure further features in a non-limiting embodiment a structure with just 5 graphene layers, significantly simplifying the design while maintaining near-perfect absorption efficiency. This hybrid approach precisely calibrates the absorption at specific mid-IR atmospheric windows, optimizing the structure for small size, weight, power, and cost. Moreover, the design exhibits high angular robustness, ensuring stable performance in real-world applications.

By leveraging aperiodic multilayer nanostructures optimized through advanced inverse design frameworks and hybrid micro-genetic algorithms, we achieved near-perfect absorption efficiencies of 99.99%. The dynamic tunability of the absorption peak was demonstrated by varying the chemical potential of graphene layers, enabling shifts of up to 0.22 μm without compromising performance. Similarly, the absorbers maintained robust performance under oblique light incidence, with absorption exceeding 90% at angles as high as 52° for some structures.

We further investigated the physical mechanisms underpinning these properties, highlighting the interplay of phase matching, surface plasmon excitation, and material refractive indices in determining the absorptive behavior. The redshift in absorption with increasing chemical potential and the blueshift with higher incident angles were explained through changes in resonance conditions and carrier density effects. Moreover, the disclosed structure demonstrated significant tolerance to fabrication errors, retaining optimal absorption performance even with ±5% variations in layer thickness.

The present findings underscore the versatility and practical applicability of the disclosed graphene-based PA design for advanced mid-IR applications such as thermal photovoltaics, environmental monitoring, and infrared sensing. The integration of tunability, compactness, and angular robustness establishes a scalable platform for the next generation of photonic and optoelectronic devices.

In conclusion, the foregoing description provides illustration and description, but is not intended to be exhaustive or to limit the inventive concepts to the precise form disclosed. Modifications and variations are possible in light of the above teachings or may be acquired from the practice of the methodologies set forth in the present disclosure.

Even though particular combinations of features are recited in the claims and/or disclosed in the specification, these combinations are not intended to limit the disclosure. In fact, many of these features may be combined in ways not specifically recited in the claims and/or disclosed in the specification. Although each dependent claim listed below may directly depend on only one other claim, the disclosure includes each dependent claim in combination with every other claim in the claim set

### CITED REFERENCES

1. Y. Yao et al., “Electrically tunable metasurface perfect absorbers for ultrathin mid-infrared optical modulators,” Nano letters, vol. 14, no. 11, pp. 6526-6532, 2014.
2. A. Safaei, S. Chandra, M. N. Leuenberger, and D. Chanda, “Wide angle dynamically tunable enhanced infrared absorption on large-area nanopatterned graphene,” ACS nano, vol. 13, no. 1, pp. 421-428, 2018.
3. L.-P. Sun, X. Zhai, Q. Lin, G.-D. Liu, and L.-L. Wang, “Tunable nearly perfect absorber based on graphene metamaterials at the mid-infrared region,” Plasmonics, vol. 13, pp. 1043-1048, 2018.
4. S. Roy and K. Debnath, “Graphene-based electromechanically tunable subwavelength mid-IR perfect absorber,” Optical and Quantum Electronics, vol. 55, no. 14, p. 1246, 2023.
5. T. D. Corrigan et al., “Broadband and mid-infrared absorber based on dielectric-thin metal film multilayers,” Applied Optics, vol. 51, no. 8, pp. 1109-1114, 2012.
6. S. Sahu and G. Behera, “Numerical study of mid-infrared broadband perfect absorber based on dielectric/aluminium doped zinc oxide multilayer films,” Optical Materials, vol. 155, p. 115776, 2024.
7. Y. Fang, L. Gong, S. Huang, S. Yan, and X. Zhang, “3-5 μm Mid-Infrared Broadband Perfect Absorber Based on Ti Ring Embedded Structure,” IEEE Photonics Journal, 2023.
8. Q. Cui, Y. Wu, Y.-X. Wang, C.-Q. Han, and C.-C. Yan, “Multilayer thin film mid-infrared broadband absorber with high visible light transmittance,” Optical Materials, vol. 157, p. 116091, 2024.
9. H. Zhang et al., “Ultra-broadband mid-infrared absorption based on photonic topological transition and anti-reflection effect,” Optics & Laser Technology, vol. 185, p. 112607, 2025
10. S. Wang, Y. Wang, S. Zhang, and W. Zheng, “Mid-infrared broadband absorber of full semiconductor epi-layers,” Physics Letters A, vol. 381, no. 16, pp. 1439-1444, 2017.

What is claimed is:

1. An aperiodic absorber nanostructure, comprising:
a support substrate comprised of gold, wherein the support substrate has a planar surface;
a first semiconductor absorber layer having a first side and a second side opposing the first side, the first side in contact with the planar surface of the support substrate, the first semiconductor absorber layer having a thickness;
a plurality of dielectric layers comprising a dielectric material, including a first dielectric layer and a last dielectric layer, each of the plurality of dielectric layers having a corresponding thickness, a first side and a second side opposing the first side, wherein the first side of the first dielectric layer of the plurality of dielectric layers is in contact with the second side of the first semiconductor absorber layer;
a plurality of graphene layers alternated with the plurality of dielectric layers after the first dielectric layer to form a stack ending with the last dielectric layer of the plurality of dielectric layers; and
a second semiconductor absorber layer having a first side and a second side opposing the first side, the first side in contact with the second side of the last dielectric layer, the second semiconductor absorber layer having a thickness; and
wherein the thickness of each of the plurality of dielectric layers, the thickness of the first semiconductor absorber layer, the thickness of the second semiconductor absorber layer, and the thickness of each of the plurality of dielectric layers, are configured for the nanostructure to meet a desired absorption level of a predetermined infrared wavelength within a range of about 3 μm to about 5 μm.

2. The aperiodic absorber nanostructure of claim 1, wherein the thickness of each of the plurality of dielectric layers, the thickness of the first semiconductor absorber layer, the thickness of the second semiconductor absorber layer, and the thickness of each of the plurality of dielectric layers, are configured for the nanostructure to meet the desired absorption level by iteratively applying a micro-genetic optimization algorithm coupled to a local optimization algorithm.

3. The aperiodic absorber nanostructure of claim 1, wherein the thickness of each of the plurality of dielectric layers, the thickness of the first semiconductor absorber layer, the thickness of the second semiconductor absorber layer, and the thickness of each of the plurality of dielectric layers, are configured for the nanostructure to meet the desired absorption level, by, iteratively:
applying a micro-genetic optimization algorithm;
evaluating results of the applied micro-genetic optimization algorithm utilizing a transfer matrix method;
assigning a fitness score indicative of alignment of the results with the desired absorption level; and
halting the iterations when the fitness score meets a predetermined level.

4. The aperiodic absorber nanostructure of claim 1, wherein the plurality of graphene layers comprises at least five graphene layers.

5. The aperiodic absorber nanostructure of claim 1, wherein the plurality of dielectric layers comprises at least six dielectric layers.

6. The aperiodic absorber nanostructure of claim 1, wherein the predetermined infrared wavelength is chosen based at least in part on desired atmospheric windows absorption.

7. The aperiodic absorber nanostructure of claim 1, wherein the absorption level of light at the predetermined infrared wavelength is at least 99.99%.

8. The aperiodic absorber nanostructure of claim 1, wherein when an incident angle of light at the predetermined infrared wavelength is between zero degrees and fifty degrees to the nanostructure, the absorption level of light at the predetermined infrared wavelength is over 90%.

9. The aperiodic absorber nanostructure of claim 1, wherein the plurality of graphene layers comprises a first graphene layer, a second graphene layer, a third graphene layer, a fourth graphene layer, and a fifth graphene layer, each graphene layer having a first side and a second side opposing the first side;
wherein the plurality of dielectric layers further comprises a second dielectric layer, a third dielectric layer, a fourth dielectric layer, and a fifth dielectric layer, each dielectric layer having a first side and a second side opposing the first side; and
wherein the first side of the first graphene layer is in contact with the second side of the first dielectric layer and the second side of the first graphene layer is in contact with the first side of the second dielectric layer, the first side of the second graphene layer is in contact with the second side of the second dielectric layer and the second side of the second graphene layer is in contact with the first side of the third dielectric layer, the first side of the third graphene layer is in contact with the second side of the third dielectric layer and the second side of the third graphene layer is in contact with the first side of the fourth dielectric layer, the first side of the fourth graphene layer is in contact with the second side of the fourth dielectric layer and the second side of the fourth graphene layer is in contact with the first side of the fifth dielectric layer, and the first side of the fifth graphene layer is in contact with the second side of the fifth dielectric layer and the second side of the fifth graphene layer is in contact with the first side of the last dielectric layer.

10. The aperiodic absorber nanostructure of claim 1, wherein the first semiconductor absorber layer and the second semiconductor absorber layer comprise a material selected from a group IV-VI semiconductor and a narrow-gap III-V compound.

11. The aperiodic absorber nanostructure of claim 10, wherein the group IV-VI semiconductor is selected from lead selenide (PbSe), lead sulfide (PbS), lead telluride (PbTe), tin selenide (SnSe), and tin telluride (SnTe).

12. The aperiodic absorber nanostructure of claim 10, wherein the narrow-gap III-V compound is selected from indium antimonide (InSb) and gallium antimonide (GaSb).

13. The aperiodic absorber nanostructure of claim 1, wherein the dielectric material is selected from the group consisting of polyphenylsulfone (PPSU), tungsten disulfide (WS₂), silicon dioxide (SiO₂), aluminum oxide (Al₂O₃), and hexagonal boron nitride (h-BN).

14. A method of making an aperiodic absorber nanostructure, comprising the steps of:
determining a thickness of each of a plurality of layers such that the nanostructure meets a desired absorption level of a predetermined infrared wavelength within a range of about 3 μm to about 5 μm, by, iteratively applying a micro-genetic optimization algorithm, and wherein the plurality of layers comprises:
a plurality of dielectric layers comprising a dielectric material, each dielectric layer having a first side and a second side opposing the first side;
a first semiconductor absorber layer having a first side and a second side opposing the first side; and,
a second semiconductor absorber layer having a first side and a second side opposing the first side, the first side in contact with a last dielectric layer, the second semiconductor absorber layer having a thickness; and
constructing the aperiodic absorber nanostructure using the determined thickness of each of the plurality of layers, by:
layering the first semiconductor absorber layer on a support substrate comprised of gold, such that the first side of the first semiconductor absorber layer is in contact with a planar surface of the support substrate;
layering a first dielectric layer of the plurality of dielectric layers on the first semiconductor absorber layer, such that the first side of the first dielectric layer is in contact with the second side of the first semiconductor absorber layer;
alternately layering a plurality of graphene layers with the plurality of dielectric layers, starting with a first graphene layer of the plurality of graphene layers and ending with a last dielectric layer of the plurality of dielectric layers; and
layering the second semiconductor absorber layer on the last dielectric layer, such that the first side of the second semiconductor absorber layer is in contact with the second side of the last dielectric layer.

15. The method of claim 14, wherein the plurality of graphene layers comprises a first graphene layer, a second graphene layer, a third graphene layer, a fourth graphene layer, and a fifth graphene layer, and wherein the plurality of dielectric layers is the first dielectric layer, a second dielectric layer, a third dielectric layer, a fourth dielectric layer, a fifth dielectric layer, and the last dielectric layer, and wherein the step of alternately layering the plurality of graphene layers with the plurality of dielectric layers comprises:
layering the first graphene layer such that the first side of the first graphene layer is in contact with the second side of the first dielectric layer and the second side of the first graphene layer is in contact with the first side of the second dielectric layer
layering the second graphene layer such that the first side of the second graphene layer is in contact with the second side of the second dielectric layer and the second side of the second graphene layer is in contact with the first side of the third dielectric layer;
layering the third graphene layer such that the first side of the third graphene layer is in contact with the second side of the third dielectric layer and the second side of the third graphene layer is in contact with the first side of the fourth dielectric layer;
layering the fourth graphene layer such that the first side of the fourth graphene layer is in contact with the second side of the fourth dielectric layer and the second side of the fourth graphene layer is in contact with the first side of the fifth dielectric layer; and
layering the fifth graphene layer such that and the first side of the fifth graphene layer is in contact with the second side of the fifth dielectric layer and the second side of the fifth graphene layer is in contact with the first side of the last dielectric layer.

16. The method of claim 14, wherein the plurality of graphene layers comprises at least five graphene layers, and the plurality of dielectric layers comprises at least six dielectric layers.

17. The method of claim 14, comprising choosing the predetermined infrared wavelength based at least in part on desired atmospheric windows absorption.

18. The method of claim 14, wherein the absorption level of light at the predetermined infrared wavelength is at least 99.99%.

19. The method of claim 14, wherein when incident angle of light at the predetermined infrared wavelength is between zero degrees and fifty degrees to the nanostructure, the absorption level of light at the predetermined infrared wavelength is over 90%.

20. The method of claim 14, determining the thickness of each of a plurality of layers further comprises, iteratively:
solving Maxwell equations and performing Finite-Difference Time-Domain (FDTD) simulations to obtain optical responses, including absorption, reflection, and transmission, for a randomized multilayer nanostructure, utilizing input parameters comprising environmental conditions, optical material properties, incident angles, quantity of layers, and temperature;
applying the micro-genetic optimization algorithm to the obtained optical responses;
evaluating results of the applied micro-genetic optimization algorithm utilizing a transfer matrix method;
assigning a fitness score indicative of alignment of the results with the desired absorption level; and
halting the iterations when the fitness score meets a predetermined level.

21. The method of claim 14, determining the thickness of each of a plurality of layers further comprises, iteratively applying the micro-genetic optimization algorithm coupled to a local optimization algorithm.

22. The method of claim 14, wherein the first semiconductor absorber layer and the second semiconductor absorber layer comprise a material selected from a group IV-VI semiconductor and a narrow-gap III-V compound.
